(19) United States
(12) Patent Application Publication
(10) Pub. No.: US 2002/0082184 A1
(43) Pub. Date: Jun. 27, 2002

(54) Hard surface cleaning composition

(76) Inventors: Steve Teasdale, Otterburn Park (CA); Corinne Lafrance, St-Amable (CA)

Correspondence Address: George A. Seaby, Seaby & Associates, 603-880 Wellington Street, Ottawa, ON, K1R 6K7, CA

(21) Appl. No.: 10/029,919

(22) Filed: Dec. 31, 2001

Related U.S. Application Data
(63) Continuation-in-part of application No. 09/692,465, filed on Oct. 20, 2000.

(30) Foreign Application Priority Data
Aug. 1, 2001 (JP) 2001-233949

(51) Int. Cl. C11D 3/00

(52) U.S. Cl. 510/392

(57) ABSTRACT

An aqueous hard surface cleaning composition contains anionic and nonionic surfactants, an enzyme mixture such as lipase/alpha-amylase for breaking down organic compounds; an activator for rendering the enzyme more active; and water. A progressively active composition also includes nonpathogenic bacteria such as a culture of Bacillus subtilis and Bacillus amyloliquefaciens for degrading and assimilating organic compounds.

This is a continuation-in-part of U.S. patent application Ser. No. 09/692,465 filed on Oct. 20, 2000.

### BACKGROUND OF THE INVENTION

1. Field of the Invention

This invention relates to a hard surface cleaning composition, and in particular to an aqueous floor cleaning composition.

While the composition of the present invention is primarily intended for cleaning restaurant kitchen floors, it can be used to clean other hard surfaces such as the floors in food processing plants which are subject to food and/or grease soiling. The composition is also useful for cleaning concrete floors such as those found in garbage rooms, merchandise receiving areas and loading docks. The composition is also very effective at cleaning pool side floors, shower and toilet floors and walls exposed to greasy dirt and/or soap scum accumulation.

2. Discussion of the Prior Art

Slipping and falling by persons working in restaurant kitchens is not uncommon. In fact, most restaurant kitchen injuries are the result of falling. Slipping occurs on wet floors, and floors soiled with food, and especially fat near frying equipment. Prior art degreasers and cleaners use chemical activity to remove greasy dirt from hard surfaces. Such cleaners can only remove surface dirt which comes into contact with the cleaner and which can be dislodged by the mechanical forces of mopping or brushing. Such cleaners are not very effective at removing greasy dirt that is trapped in porous surfaces such as grout.

This is a major drawback since it has been shown by using confocal laser microscopy (Underwood, D. C., 1992. Ceram. Eng. Sci. Proc. 13(1-2) pp. 78-85) that typical flooring is highly porous. Although the surface of a typical floor covering may appear smooth, it is made of a series of peaks, valleys and channels which act as reservoirs for greasy dirt. Thus, the floor covering acts as a greasy dirt reservoir that is not entirely accessible to prior art degreasers and cleaners. The use of such cleaners leads to incomplete degreasing of surfaces and promotes re-soiling of floors immediately following cleaning.

Although some prior art cleaners such as the one disclosed in U.S. Pat. No. 5,422,030, issued to Panandiker et al on Jun. 6, 1995 describe the use of an enzymatic component to improve the efficiency of chemical detergents, such cleaning compositions do not perform “deep” degreasing of hard surfaces. Most enzymatic detergent compositions are directed to proteinacious dirt removal and some such compositions include a secondary facultative lipolytic enzyme to remove greasy soil. It is well known, however, that lipolytic enzymes are not effective at improving greasy soil removal in laundry applications. Furthermore, such laundry detergent compositions are not effective at providing deep degreasing of hard surfaces since their protease component acts against any possible long term degreasing activity of lipolytic enzymes which are themselves proteins and subject to protease degrading activity. Deep degreasing is only possible if lipolytic action is maintained for a long period of time. In that case, the presence of protease enzymes is conflictual.

Accordingly, there is a need for a hard surface degreaser effective at deep degreasing of hard surfaces for the removal of greasy dirt that is present both at the surface and in pores below the hard surface.

### GENERAL DESCRIPTION OF THE INVENTION

An object of the present invention is to provide a hard surface cleaning composition for floors which effectively degreases an entire floor area including tile grout and other porous surfaces.

Another object of the invention is to provide a hard surface cleaning composition which is progressively active, i.e. continues to be active over a relatively long period of time after being applied to a surface.

In its simplest form, the composition of the present invention includes at least one surfactant, an enzyme mixture for breaking down organic compounds such as fats, oils, grease and starch; and water.

In a second embodiment, the composition of the present invention includes at least one surfactant; an enzyme mixture for breaking down organic compounds such as fats, oils, grease; nonpathogenic bacteria for degrading and assimilating organic compounds such as fats, oils, greases, protein and starch; and water.

More specifically, the invention provides an aqueous hard surface, liquid cleaning composition containing an anionic and a nonionic surfactant; an enzyme mixture such as lipase (triacylglycerol acylhydrolase, E.C. 3.1.1.3) / alpha-amylase (E.C.3.2.1.1); an enzyme activator such as calcium chloride dihydrate for rendering the enzymes more active; a stabilizer such as anhydrous sodium acetate; a buffer such as tris (hydroxymethyl) aminomethane, and water. When a bacteria is used in the composition, it is preferably a nonpathogenic Bacillus bacteria. When an esterase is used in the composition, it is preferably carboxylester hydrolase E.C.3.1.1.1).

The surfactants increase the bioavailability of the dirt, facilitate the solubilization of greasy dirt, lower the surface tension and increase surface activity in the composition. By working immediately when the composition is applied to a surface, the surfactant is considered to be the “short term” activity portion of the composition. The calcium chloride dihydrate stabilizes the lipase and removes free fatty acids from the reaction system by the formation of Ca²⁺ salt, thereby preventing inhibition of the enzyme and re-association of the free fatty acids with hydrolyzed fat molecules (diglycerides, monoglycerides and glycerol).

In addition to lipase, the composition can also contain an alpha-amylase and/or esterase, which broadens the cleaning activity of the formulation. With repeat usage, the enzymes break down organic compounds located at the surface and also inside the porous regions of the hard surface. The enzyme lipase catalyzes the hydrolysis of triacylglycerides (fats) into diglycerides, monoglycerides, free fatty acids and glycerol. The enzyme alpha-amylase catalyzes the hydrolysis of polysaccharides such as starch into smaller sugars such as maltose. The enzyme esterase catalyses the cleavage of ester bonds of water soluble substrates. The activity of the enzymes is immediate and long lasting, starting as soon as the composition is applied to the surface being treated and lasting as long as a minimum of dampness is maintained on the surface and inside the surface covering, the tile grout and cracks. The activity will also last as long as the enzymes are in good condition and not retro inhibited by accumulation of metabolites. In porous material, the activity can last for hours. The enzyme mixture is lipolytic and facultatively amylolytic and/or esterasic, but not proteolytic. The presence of any significant amount of protease in the composition hinders the long term degreasing effect of the composition by degrading the non proteolytic enzyme such as the lipases. This incompatibility of protease with lipase and other non proteolytic enzymes is well known. This problem is described in U.S. Pat. No. 5,422,030, issued on Jun. 6, 1995, Panandiker et al. Panandiker describes the use of boric acids to inhibit the protease enzyme in the composition and in turn prevent lipase and other non proteolytic enzyme degradation. The inhibitory effect of boric acid is reversible with protease activity being restored when the product is diluted. Protease, then starts to degrade any protein in the surrounding environment including lipase and other none proteolytic enzymes. In the present invention, lipase activity is stable and not compromised by any other ingredient and in turn provides for mid to long term degreasing activity.

The bacteria used in the composition (Bacillus subtilis and Bacillus amyloliquefaciens) play a major role in the composition described herein. They are introduced in the composition as bacterial spores to ensure long-term stability. The activity of the bacteria is progressive, i.e. after dilution and spreading of the composition on a surface, the bacterial spores start to germinate and can take up to three hours to become fully active. The bacterial activity can last up to twenty-four hours in normal humidity. The smaller molecules produced by the hydrolysis of the complex organic compounds by the enzyme mixture become available for the bacteria. Then the bacteria will start growing and producing their own lipase, protease and amylase enzymes, becoming very effective at degrading various organic compounds including fats and starch. The bacterial population can produce protease without compromising the long term degreasing effect of the composition. Protease produced by the bacterial population only starts to be released in small amounts hours after the composition has been applied to the surface.

It has been found through experimental use that the biologically active fractions of the composition can provide progressive and continuous cleaning and degreasing activity when the composition is applied to a surface on a daily basis. When repeatedly cleaned with the composition, preferably on a daily basis for at least five days, a floor for example will progressively become less and less slippery and will also progressively regain substantially its original look and aspect.

### DESCRIPTION OF THE PREFERRED EMBODIMENT

A preferred composition is set out in the following table.

| | | TABLE | |
|---|---|---|---|
| | | WEIGHT PERCENT | |
| INGREDIENT | FUNCTION | Range | Preferred |
| Water | solvent | 50-65 | 61.04 |
| Dodecylbenzene sulfonic acid | anionic surfactant | 5-30 | 15.00 |
| Ethoxylated propoxylated C₁₂-C₁₅ alcohols | nonionic surfactant | 5-30 | 15.00 |
| Sodium hydroxide (50%) | neutralizer for dodecylbenzene | 2-8 | 4.02 |
| | sulfonic acid | | |
| Tris(hydroxymethyl) aminomethane | buffer | 0-4 | 0.30 |
| Anhydrous sodium acetate | stabilizer | 1-5 | 2.40 |
| Lipase/Alpha-amylase/esterase | enzyme mixture | 0.1-10 | 1.80 |
| Hydrochloric acid | pH control | 0-1 | 0.1 |
| Calcium chloride dihydrate | activator | 0.02-0.5 | 0.05 |
| 1,2-benzisothiazolin-3-one | preservative | 0.03-0.2 | 0.08 |
| Lime green | colorant | 0-0.1 | 0.0016 |
| Citrus fragrance | perfume | 0-1.5 | 0.1 |
| Bacillus subtilis and Bacillus | bacteria | 0-10 0.1 | |
| amyloliquefaciens | | | |

The preferred anionic surfactant is dodecylbenzene sulfonic acid. It is manufactured by Stepan. Other anionic surfactants that provide good solvency, low surface activity, do not cause excessive foaming and that are compatible with the enzymatic and bacterial portion of the composition, can also be used.

The preferred nonionic surfactant is manufactured by Rhone Poulenc and is available under the trade-mark ANTAROX LAEP59. It is an ethoxylated and propoxylated C₁₂-C₅ linear alcohol. Other nonionic surfactants that provide good solvency and low surface activity without causing excessive foaming, and that are compatible with the enzymatic and bacterial portion of the composition, can also be used.

The anhydrous sodium acetate used to stabilize the enzyme is produced by Macco. The lipolytic enzyme solution is obtained from Innu-science Canada Inc. It can be used in a purified or a non purified form, but non purified crude extracts are as effective as purified forms, they appear to be more stable as long as no protease activity is present and they are more economically sound. To be used in the concentration range as set out above, each milliliter of the enzyme solution should be able to liberate from 100 000 to 500 000 micro mole of free fatty acid per minute at 37° Celsius when olive oil is used as a substrate.

Most lipase of microbial origin can be used. Lipase produced by bacteria such as Pseudomonas, Chromobacter and Bacillus are particularly suitable. Most lipase of fungal origin can be used provided that it is stable. Lipase produced by fungies like Humicola sp., Aspergillus sp. and Penicillium sp. are particularly suitable. Lipase produced by yeast like Pichia sp. can also be used. Recombinant and non recombinant enzymes can be used in the present composition. Enzymes produced by wild type and genetically modified organisms can be used in the present composition.

The 1,2-benzisothiazolin-3-one, is a bacteriostatic substance and it prevents bacterial deterioration of the composition. It is manufactured by Avicia. The colorant is made by Warner Jenkinson, and the perfume by Ess. et Frag. Bell. Both colorant and fragrance are facultative. Any colorant and fragrance that are compatible with the enzymatic and bacterial activity of the composition can be used.

The bacterial culture used in the present composition is produced by Innu-Science Canada Inc. The preferred bacterial culture does not contain pathogenic or opportunistic bacteria and it contains a high rate of sporulated bacteria to ensure long-term stability once introduced into the composition. Preferably, before being introduced into the formulation, the bacterial culture is washed at least twice to ensure that no residual proteolytic activity is introduced into the formulation. To be used in the concentration range as set out above, each milliliter of the bacterial culture should contain from 1×⁷ to 5×¹⁰ bacteria per milliliter (also expressed as pfu/ml). The bacteria used in the present composition exhibit very strong lipolytic activity and are fast growers. Any non pathogenic and non toxigenic Bacillus bacteria that is a fast grower, that can sporulate to a large extent and that is able to biodegrade from 500 to 50,000 ppm of vegetable oil per 24 hours when incubated in a nutritive liquid media, is suited for the present composition. The final concentration of the bacteria in the composition is preferably from 1×10⁴ to 5×10⁹ pfu/ml.

The hydrochloric acid is used to adjust the pH of the composition to 6.5-9.0, preferably 8.2-8.5.

As mentioned above, the composition is primarily intended for use on kitchen floors. In commercial or other high use kitchens, the floor should be cleaned at least once a day using a mop. The composition is diluted with warm water at approximately 40° C. (avoiding the use of excessive hot water which adversely affects the activity of the composition), using approximately 50 to 200 parts by volume of water for 1 part composition. Dilution 1/50 is best suited for first time usage of the composition and/or for heavily soiled surfaces while 1/200 dilution is suited for routine cleaning. The product is brushed or mopped over the floor surface and is either rinsed or left in place after cleaning. The best results are achieved when the composition is left on the floor for a minimum of 10 to 15 minutes and then rinsed with fresh water. Even when used for the first time, the product starts to penetrate the floor covering, the tile grout and the cracks. Even after rinsing or after apparent surface drying, all porous surfaces are left impregnated with a biologically active composition that continues hydrolyzing and degrading greasy soil material for hours. The results of this unique continuous cleaning process is particularly obvious in the first days of usage of the composition. Each time the composition is used, greasy dirt is removed from the inside of the porous surfaces progressively freeing them of their greasy content and giving them their original color and aspect and thereby progressively reducing slippage. Depending on the state and type of flooring, this restorative phenomenon is typically disappearing after 5 to 15 repeated usages of the composition as the impregnated greasy soil is completely removed from the inside of the covering.

The long term cleaning effect of the composition is also noticeable in the appearance of the mop used to apply the composition. Mops used to apply traditional chemical cleaners rapidly deteriorate by developing a dark and unpleasant coloration caused by greasy dirt accumulation in the braid. This grease accumulation results in frequent replacement of mops. Since the long term cleaning activity of the composition also persists in the mop after cleaning and before complete drying, it has a beneficial impact on their utility life by reducing grease accumulation in the braid. Mops used to apply the disclosed composition have been found to have a utility life that is from 2 to 5 times longer as compared to mops used to apply traditional chemical cleaners.

To optimize the starting effect of the disclosed composition and to accelerate the completion of the restorative phenomenon, a preferred method of applying and using the composition when used for the first time is provided below. This method is referred as “The Dubé Method™”. For the second and subsequent applications of the composition, the method as described above is appropriate.

Description of The Dubé Method™

1. Dilute 1 part of the composition in 50 parts of lukewarm water;

2. Spread a fair amount of the diluted composition on the floor surface;

3. Wait for 15 minutes;

4. Use a brush to scrub the dirt out of the floor; and

5. Using a mop, rinse with a fresh solution of composition (1:200 dilution) and let dry.

Since grease is the universal base of soil sticking to surfaces, the composition of the present invention can be used on any floor subjected to soilage. For example, the composition provides unique cleaning effects for concrete floors such as those found in garbage rooms, merchandise receiving areas and loading docks. The composition is also very effective at cleaning pool side floors, shower and toilet floors and walls exposed to greasy soil and/or soap scum accumulation.

We claim:

1. A liquid, hard surface cleaning composition comprising a surfactant; an enzyme mixture for breaking down organic compounds; an enzyme activator for rendering the enzyme mixture more active; a nonpathogenic Bacillus bacteria having a final concentration from 1×10⁴ to 5×10⁹ pfu/ml, and water.

2. The cleaning composition of claim 1, including an anionic and a nonionic surfactant.

3. The cleaning composition of claim 2, wherein said enzyme mixture contains lipase.

4. The cleaning composition of claim 3, wherein said enzyme activator is calcium chloride dihydrate.

6. The cleaning composition of claim 1, wherein said bacteria is a mixture of Bacillus subtilis and Bacillus amyloliquefaciens.

7. The cleaning composition of claim 1, wherein said enzyme mixture includes esterase and amylase.

8. An aqueous hard surface cleaning composition comprising, by weight, 10-30% dodecylbenzene sulfonic acid; 10-30% ethoxylated propoxylated C₁₂-C₁₅alcohols; 2-8% sodium hydroxide; 0-4% tris (hydroxymethyl) aminomethane; 1-5% anhydrous sodium acetate; 0.1-10% lipase/alpha-amylase mixture; 0-1% hydrochloric acid; 0.02-0.5% calcium chloride dihydrate; 0.03-0.2% 1,2-benzisothiazolin-3-one; 0.1-10% of a culture of Bacillus subtilis and Bacillus amyloliquefaciens having a final concentration from 1×10⁴ to 5×10⁹ pfu/ml; and 50-65% water.

9. An aqueous, hard surface cleaning composition comprising, by weight, 15% dodecylbenzene sulfonic acid; 15% ethoxylated propoxylated C₁₂-C₁₅ alcohols; 4.02% NaOH; 0.30% tris (hydroxymethyl) aminomethane; 2.40% anhydrous sodium acetate; 1.80% lipase/alpha-amylase mixture; 0.1% hydrochloric acid; 0.05% calcium chloride dihydrate; 0.08% 1,2-benzisothiazolin-3-one; 0.1% of a culture of Bacillus subtilis and Bacillus amyloliquefaciens having a final concentration of 3×10⁷ pfu/ml ; and balance water.

10. A liquid, hard surface cleaning composition comprising a surfactant; an enzyme mixture for breaking down organic compounds; an enzyme activator for rendering the enzyme mixture more active and water.

11. The cleaning composition of claim 10, including an anionic and a nonionic surfactant.

12. The cleaning composition of claim 10, wherein said enzyme mixture contains lipase.

13. The cleaning composition of claim 10, wherein said enzyme mixture contains amylase and esterase.

14. The cleaning composition of claim 10, wherein said enzyme activator is calcium chloride dihydrate.

15. An aqueous, hard surface cleaning composition comprising an anionic and a nonionic surfactant; a neutralizer for the anionic surfactant; a buffer; a stabilizer; an enzyme mixture for breaking down organic compounds; an enzyme activator for rendering the enzyme more active; an inorganic acid for adjusting the pH of the composition and a preservative.

16. An aqueous hard surface cleaning composition comprising, by weight, 10-30% dodecylbenzene sulfonic acid; 10-30% ethoxylated propoxylated C₁₂-C₅alcohols; 2-8% sodium hydroxide; 0-4% tris (hydroxymethyl) aminomethane; 1-5% anhydrous sodium acetate; 0.1-10% lipase/alpha-amylase mixture; 0-1% hydrochloric acid; 0.02-0.5% calcium chloride dihydrate; 0.03-0.2% 1,2-benzisothiazolin-3-one and 50-65% water.

17. An aqueous, hard surface cleaning composition comprising, by weight, 15% dodecylbenzene sulfonic acid; 15% ethoxylated propoxylated C₁₂-C₁₅ alcohols; 4.02% NaOH; 0.30% tris (hydroxymethyl) aminomethane; 2.40% anhydrous sodium acetate; 1.80% lipase/alpha-amylase mixture; 0.1% hydrochloric acid; 0.05% calcium chloride dihydrate; 0.08% 1,2-benzisothiazolin-3-one and the balance being water.
